(19) United States
(12) Patent Application Publication
(10) Pub. No.: US 2025/0018915 A1
(43) Pub. Date: Jan. 16, 2025

(54) PARKING BRAKE DEVICE FOR VEHICLES

(71) Applicant: AKTIEBOLAGET SKF, GOTEBORG (SE)

(72) Inventors: Fortunato PEPE, Nichelino (IT); Giuseppe QUAGLIA, Piscina (IT); Luca CARBONARI, Filottrano (IT)

(21) Appl. No.: 18/713,739

(22) PCT Filed: Nov. 24, 2022
(86) PCT No.: PCT/EP2022/083084

§ 371 Date: May 29, 2024

(30) Foreign Application Priority Data
Dec. 1, 2021 (IT) 102021000030371

(51) Int. Cl. B60T 13/74; F16D 65/18; F16D 125/68; F16D 125/70; F16D 127/06

(52) U.S. Cl. CPC B60T 13/746; F16D 65/18; F16D 2125/68; F16D 2125/70; F16D 2127/06

(57) ABSTRACT

A vehicular parking brake includes a braking device, a linear actuator, a first tie rod connected to the linear actuator, a second tie rod connected to the braking device, and a motion transmitting mechanism connecting the first tie rod to the second tie rod with a variable transmission ratio that varies based on a reaction force produced by the braking device.

### TECHNICAL FIELD OF THE INVENTION

The present invention relates to a device for braking of vehicles in a parking mode, which is capable of ensuring high braking torque/force and rapid activation.

### PRIOR ART

As is known, when a vehicle is parked it must be ensured that the vehicle does not move accidentally, for example as a result of external forces or, in the case of parking on a slope or inclined ramp, the force of gravity. This function is performed by the parking brake, also referred to in the past as the “hand brake” as it was usually a lever with a harpoonism operated manually by a user, which tensioned a cable, mechanically activating respective brake shoes on the wheels of a vehicle axle, locking them so as to prevent them from rotating.

In current vehicles the parking brake function is increasingly performed by a mechatronic device generally engaged automatically, when the vehicle is stationary with the engine off.

A first type of parking brake device, referred to as MOC (Motor On Caliper), consists of an electric actuator borne directly by the brake caliper and acting on the brake pads, placing them in a braking position. This device is generally expensive and may be relatively bulky, sometimes excessively so. A second type of parking brake device, referred to as a “cable puller”, comprises a linear electric actuator, for example of the worm screw type, which actuates a tie rod, which in turn mechanically actuates a braking device (brake shoe or caliper) acting on the wheels of the vehicle.

The braking device, whether that normally present on the wheels of the vehicle and actuated while the vehicle is moving by the vehicle braking system, or an additional braking device purely for braking in parking mode, necessarily has a two-phase activation stroke:
in a first phase, the linear movement of the tie rod takes up the play necessarily present at rest (i.e. in the disengaged state) between the braking element (for example brake shoe or brake pad) and the element to be braked (for example brake disk or drum), in such a way as to bring the former right up against the latter; in this phase the actuator must exert only a limited force in relation to a relatively long linear stroke;
in a second phase, the actuator must press the braking element against the element to be braked with increasing force, in such a way as to frictionally block the rotation of the element to be braked, in the face of a limited stroke (5-20 mm). The braking torque thus exerted is translated into a linear force acting on the tie rod, which must be counteracted and overcome by the actuator.

This type of actuation on the one hand results in a relatively long time for engagement of the parking brake device owing to a relatively long “rest” stroke and, on the other hand, makes it necessary to use actuators dimensioned for the maximum force to be exerted on the tie rod and, therefore, for the maximum torque to be applied to the braking element. This results in a relatively long waiting time (up to around ten seconds) before the user can leave the vehicle and in higher structural costs, greater bulk and less efficiency of the parking brake device as a whole.

### SUMMARY OF THE INVENTION

The aim of the present invention is to provide a parking brake device for vehicles, of mechatronic type, which can be engaged automatically but does not have the drawbacks of the prior art. The invention aims in particular to produce a parking brake device of the “cable puller” type which however allows rapid application of the braking torque to the vehicle wheels while at the same time being of relatively simple structure and limited cost and bulk.

The invention therefore provides a parking brake device for vehicles having the features set out in the attached claims.

### BRIEF DESCRIPTION OF THE DRAWINGS

The invention will now be described with reference to the attached drawings, which show a number of non-limiting embodiments of the invention, in which:

FIG. 1 schematically shows a parking brake device produced according to the invention, having a reconfigurable transmission mechanism arranged between a braking device and an actuator for said device, the reconfigurable transmission mechanism being depicted in a first configuration in which the parking brake device is disengaged;

FIGS. 2 and 3 schematically show the reconfigurable transmission mechanism of the parking brake device of FIG. 1, depicted respectively in a second and in a third configuration of operation, in which the parking brake device of FIG. 1 is progressively engaged;

FIGS. 4, 5 and 6 schematically show a first alternative of the reconfigurable transmission mechanism of the parking brake device of the invention, shown in the same configurations of operation of FIGS. 1, 2 and 3, respectively;

FIG. 7 schematically shows, in simplified form, a first embodiment of a force amplification mechanism applicable to the reconfigurable transmission mechanism of FIGS. 1-6 and usable in the parking brake device according to the invention;

FIGS. 8 and 9 schematically show a second alternative of the reconfigurable transmission mechanism of the parking brake device of the invention, shown in the same configurations of operation of FIGS. 2 and 3, respectively;

FIGS. 10 and 11 show, respectively, schematically and in simplified form, a second and a third embodiment of a force amplification mechanism applicable to the reconfigurable transmission mechanism usable in the parking brake device according to the invention;

FIGS. 12 and 13 schematically show the components of two further alternatives of the reconfigurable transmission mechanism of the parking brake device of the invention; and

FIGS. 14 and 15 depict by means of respective (locking) force/movement (stroke) graphs, the performance in terms of operation that can be obtained with the parking brake device according to the invention.

### DETAILED DESCRIPTION

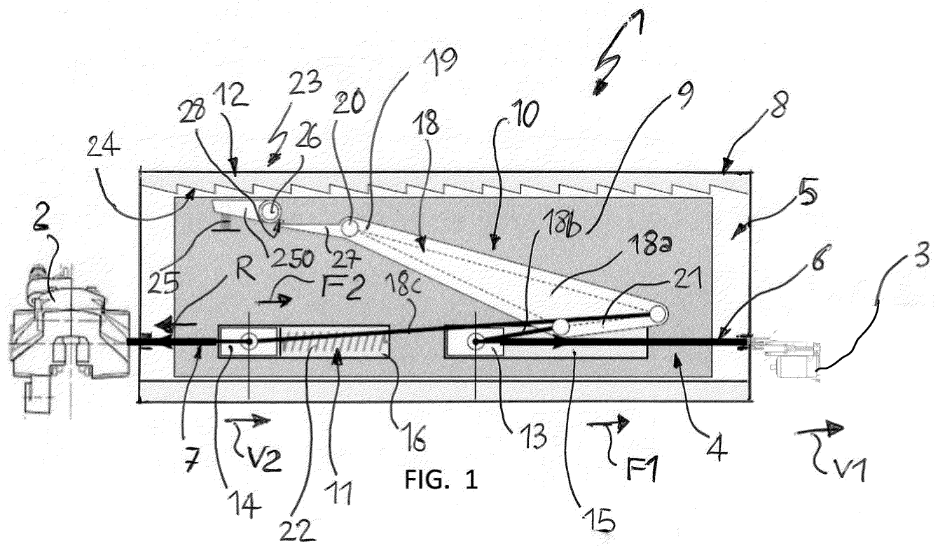

Referring to FIGS. 1 to 3, the reference sign 1 generally designates a device for braking of a vehicle in a parking mode, which is known and not shown for the sake of simplicity.

The parking brake device 1 is of the type comprising a braking device 2 for braking of the vehicle, which is known, for example a brake caliper, and a linear actuator 3, which is known overall, for example electric, configured to actuate the braking device 2 by means of a tie rod 4 interposed between the braking device 2 and the linear actuator 3.

The parking brake device 1 further comprises, according to one aspect of the invention, a motion transmitting mechanism 5 mechanically inserted in series on the tie rod 4, so as to subdivide the same into a first section 6 connected to the linear actuator 3 and into a second section 7, opposite to the first section 6, connected to the braking device 2.

According to one aspect of the invention, the motion transmitting mechanism 5 is configured to connect with a variable transmission ratio the second section 7 with the first section 6, so that a translatory movement at a first speed V1 of the first section 6, following the actuation of the linear actuator 3 reconfigures automatically, as will be seen below, the motion transmitting mechanism 5 to vary its transmission ratio and cause a translatory movement of the second section 7 with a second speed V2 which is a function of a reaction force R (indicated by the arrow in FIG. 1 alongside the section 7 of the tie rod 4 and also on the section 7 itself) applied by the braking device 2 to the second section 7, as the braking device 2 is engaged or disengaged.

According to one aspect of the invention, the speed V1 in the phase of engagement of the braking device 2 is identical to the speed V2 (and therefore the transmission ratio of the mechanism 5 is equal to 1) until the reaction force R reaches a predetermined value. When the reaction force R exceeds this predetermined value or threshold, the motion transmitting mechanism 5 is reconfigured, as will be seen below, its transmission ratio being progressively changed, making it always less than 1, so that the speed V2 progressively falls below V1 while, in parallel, on the basis of known laws of physics, the force exerted on the section 7 of the tie rod 4 by the linear actuator 3 increases, opposing and overcoming the reaction force R.

According to a non-secondary aspect of the invention, to achieve this result, the motion transmitting mechanism 5 comprises: a support 8 stationary with respect to the first and second sections 6,7 of the tie rod 4; a frame 9 carried by the support 8 slidingly movable parallel to the tie rod 4; a force amplification mechanism 10 carried by the frame 9 and mechanically connecting together with a selectively variable transmission ratio the first section and second section 7 of the tie rod 4 to move the second section 7 in consequence of a linear movement of the first section 6; a triggering system 11 configured to selectively activate the force amplification mechanism 10 to vary its transmission ratio when the reaction force R exceeds said predetermined value; and a force exchange system 12 between the stationary support 8 and the movable frame 9 configured to block the sliding of the movable frame 9 and make it integrally rigid with the support 8.

According to one aspect of the invention, the force amplification mechanism 10 is configured to actuate the force exchange system 12, following the activation of the force amplification mechanism 10 itself by the triggering system 11, and for applying to the second section 7 of the tie rod 4, always following the activation by the triggering system 11, a force F2 progressively increasing and always greater than the reaction force R. Moreover, the force amplification mechanism 10 and the force exchange system 12, when activated, are configured to discharge onto the support 8 a portion of the reaction force R such that, while the linear actuator 3 applies to the first section 6 a first force F1 that is substantially constant, the force amplification mechanism 10 applies to the second section 7 of the tie rod 4 a second force F2 that is always greater than the first force F1 and the reaction force R (F2 and R are reactions relating to the same section of tie rod, and therefore F2=R).

According to the many alternative embodiments shown, which will now be described in detail, one by one, the force amplification mechanism 10 comprises one or more levers or connecting rods 18 articulately constrained to the frame 9 and hingedly bound to each other and/or with at least one pair of skids 13,14 slidably housed, in the non-limiting example shown, within respective guides 15, 16 obtained on/carried by the frame 9; wherein said first and second sections 6, 7 of the tie rod 4 are constrained to the at least one or more levers or connecting rods 18 and/or to the skids 13,14. In a manner obvious to those skilled in the art, it is clear that the guides 15, 16 may be replaced with equivalent elements, for example the sliding coupling may take the form of a bushing (or sleeve) that slides on the cylindrical element (in any case of limited length).

In the first non-limiting embodiment of the invention shown schematically in FIGS. 1-3 in three different positions of operation thereof, the motion transmitting mechanism 10 comprises a triangular lever or member 18a which is hinged at a first end thereof 19, constituting the vertex of a triangle, to a bolt 20 carried integral by the frame 9. An opposite end 21 of the lever or member 18a constitutes a side of a triangle, opposite the vertex 19 and is hinged, at the relevant adjacent vertices of said triangle formed by the lever 18a, with two connecting rods 18b and 18c respectively hinged to the skid 13 and to the skid 14. The section 6 of the tie rod 4 is integrally rigid with the skid 13, while the section 7 of the tie rod 4 is integrally rigid with the skid 14.

According to another aspect of the invention, the triggering system 11 is configured to lock the force amplification mechanism 10 by preventing any relative rotation between the at least one or more levers or connecting rods 18 and the frame 9 until the reaction force R exceeds the predetermined value; below said predetermined value, the linear actuator 3 (FIG. 1) consequently drags the frame 9 by means of the section 6 of the tie rod 4; the frame 9, sliding relative to the support 8, in turn drags the second section 7 of the tie rod 4 by means of the locked force amplification mechanism 10 which is locked by the triggering system 11 (the articulated mechanism 10 in fact acts, when locked, as a rigid system for connection between the sections 6 and 7 of tie rod 4) and hence with a transmission ratio equal to 1. The skids 13 and 14 do not move along the respective guides 15,16 (or equivalent elements).

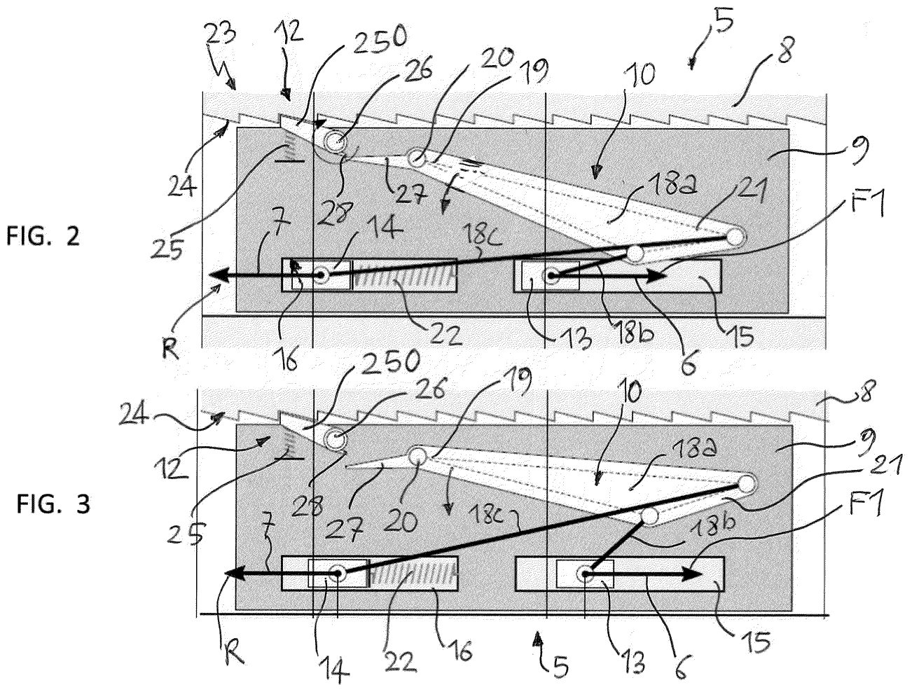

Above said predetermined value of the reaction force R applied by the braking device 2 to the section 7 of the tie rod 4, the sliding motion of the frame 9 with respect to the support 8 is blocked, as will be seen below (FIG. 2), and the linear actuator 3 thus drags the second section 7 of the tie rod 4 by means of a relative movement of the force amplification mechanism 10 with respect to the frame 9 (FIG. 3), with a transmission ratio lower than 1 and progressively reduced (by virtue of the geometry given to the lever 18a and the connecting rods 18b and 18c) as the reaction force R increases.

In the non-limiting example shown in FIGS. 1-3, the triggering system 11 consists in a calibrated spring 22 having a predetermined stiffness, inserted in the guide 16 in such a way as to counteract the movement of the skid 14 towards the guide 15 to keep the skid 14 normally in the position of FIG. 1.

When the reaction force R exceeds said predetermined value, the force F2 which the mechanism 10 is to apply to the section 7 of the tie rod 4 exceeds the preload force of the spring 22, which begins to compress, allowing the skid 14 to move inside the guide 16 getting closer to the guide 15. This movement is accompanied by a similar sliding movement in the same direction of the skid 13 in the guide 15, the skid 13 sliding towards the linear actuator 3.

This initial movement of the skids 13, 14 produces the initial rotation of the lever 18a about the bolt 20, which activates the force exchange system 12 blocking the sliding of the frame 9 (FIG. 2). At this point (FIG. 3) the linear actuator 3 can drag the section 7 of the tie rod 4 only through the movement of the motion transmitting mechanism 10, which is configured precisely (by giving the lever 18a and the connecting rods 18b and 18c the appropriate dimensions) to progressively reduce the transmission ratio in such a way as to apply to the section 7 a progressively increasing force F2, while the force F1 remains substantially constant.

In the non-limiting example shown in FIGS. 1-3, the force exchange system 12 consists of a harpoonism 23 comprising a toothing 24 obtained integral with the support 8 and a deadlock 250 urged by a spring 25 and constrained hinged in a rocking manner at a bolt 26 to the frame 9 so as to cooperate with, or be constrained to, the force amplification mechanism 10 to be prevented by the latter from engaging the toothing 24 until the reaction force R exceeds said predetermined value.

In particular, in the example of implementation of FIGS. 1-3, the harpoonism 23 cooperates with the lever 18a of the mechanism 10 by means of an arm 27 obtained integral with the end 19 and projecting radially from the bolt 20 on the opposite side to the end 21 and by means of a corresponding fin 28 integral with the deadbolt 250 and projecting radially from the bolt 26 on the opposite side to the toothing 24.

In a parking brake device 1 which is deactivated and/or in the first initial phase of activation thereof (FIG. 1), the arm 27 bears against the fin 28 and counteracts the action of the spring 25 which, contrarily, pushes the deadbolt 250 in a direction such as to cause it to engage the toothing 24. Therefore, the deadbolt 250 cannot engage the toothing 24, as it is immobilized by the arm 27, and the frame 9 is thus free to slide with respect to the support 8 parallel to the tie rod 4.

As soon as the reaction force R exceeds said predetermined value, the lever 18a begins to rotate towards the guide 16 and the arm 27 progressively loses contact with the fin 28; consequently, the spring 25 can push the deadbolt 250 to engage the toothing 24 (FIG. 2).

At this point, the frame 9 is locked and can no longer slide on the support 8 and the motion transmitting mechanism 10 comes into play in the manner described above. The difference between the forces F1 (which remains constant) and F2 (which increases progressively as the action of the linear actuator 3 proceeds and which is proportional to the reaction force R applied by the braking device 2 to the section 7 of the tie rod 4) is absorbed by/discharged on the support 8, via the frame 9 and the harpoonism 23 in the engaged position (FIG. 3).

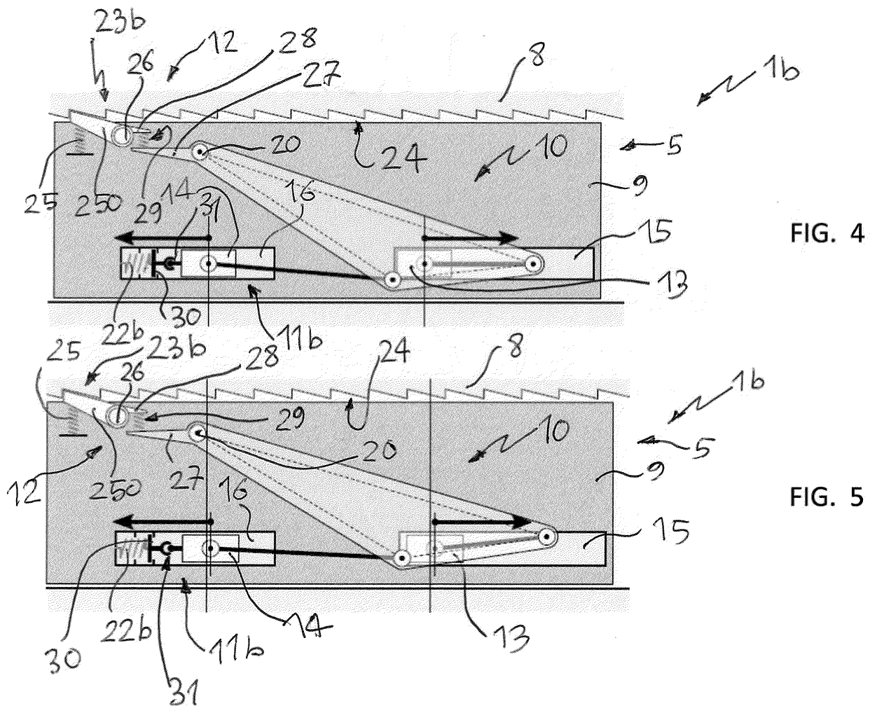

Note that, as the stroke of engagement/activation of the braking device 2 continues, the skid 13 goes beyond the position shown in FIG. 3 and reaches an end-of-stroke against the end of the guide 15 away from the guide 16. During this movement, the connecting rod 18b rotates progressively towards the guide 16 exceeding (as can be seen clearly in the drawings) a dead center (not shown for the sake of simplicity) corresponding to a position of the connecting rod 18b transverse (substantially perpendicular) to the tie rod 4. Therefore, at the end-of-stroke, the motion transmitting mechanism 10 is in a position of irreversibility, whereby the braking device 2 remains engaged (i.e. a force F1 equal and opposite to the reaction force R remains applied on the section 7 of the tie rod 4) without it being any longer necessary to have the linear actuator 3 operational and activated, i.e. also with a force F1 equal to zero. FIGS. 4, 5 and 6 schematically show a second embodiment 1b of the parking brake device of the invention. Details which are similar or identical to those already described are indicated for the sake of simplicity with the same reference numbers.

The device 1b is substantially identical to the parking brake device 1 just described, except that the triggering system 11 is replaced by a triggering system 11b and the force exchange system 12 consists of a harpoonism 23b which differs slightly from the harpoonism 23 described above.

To be specific, the harpoonism 23b is identical to the harpoonism 23 except that, in addition to the toothing 24, the deadbolt 250 with its fin 28, the spring 25 and the connecting bolt 26, it further comprises a second spring 29 interposed between the fin 28, to which it is rigidly secured, and the arm 27. This configuration has the advantage that the arm 27 “pushes” on the fin 28 not directly, but via the spring 29, which allows the harpoonism 23b to function correctly even the event of negative strokes of the “user” skid 14 (i.e. when the skid is moved towards the end of the guide 16 away from the guide 15).

Reciprocally, the triggering system 11b differs slightly from the triggering system 11 described above, in that it comprises a calibrated spring 22b arranged in the guide 16 at the opposite end to the spring 22 and cooperating with a sliding skid 30, which is bound to the skid 14 by means of a snapping action coupling 31. In all other respects, the operation of the device 1b is identical to that of the device 1 described above.

To be specific, the snapping action coupling 31 is the device tasked with releasing the skid 14 when the predetermined value of R is reached. The spring 22b thus has the dual function of:
Getting the right balance of internal forces for disengaging the harpoon 250 as the brake is released;
Bringing the skid 14 back into its initial configuration when the brake release stroke comes to an end.

As soon as the spring 22b allows the skid 14 to move, then the deadbolt 250 can engage the toothing 24; meanwhile, the movement of the skid 30 is stopped by an end-of-stroke carried by the guide 16 and the snapping action coupling 31 disengages as a result, while the skid 14, dragged by the skid 13 via the connecting rod 18c continues its stroke towards the guide 15 allowing the articulated device made up of the lever 18a and the connecting rods 18b and 18c to progressively attain end-of-stroke (FIGS. 4 and 5) causing the connecting rod 18 to pass through a point of kinematic singularity (dead center-connecting rod 18b perpendicular to the tie rod 4) which ensures the kinematic irreversibility of the mechanism 10.

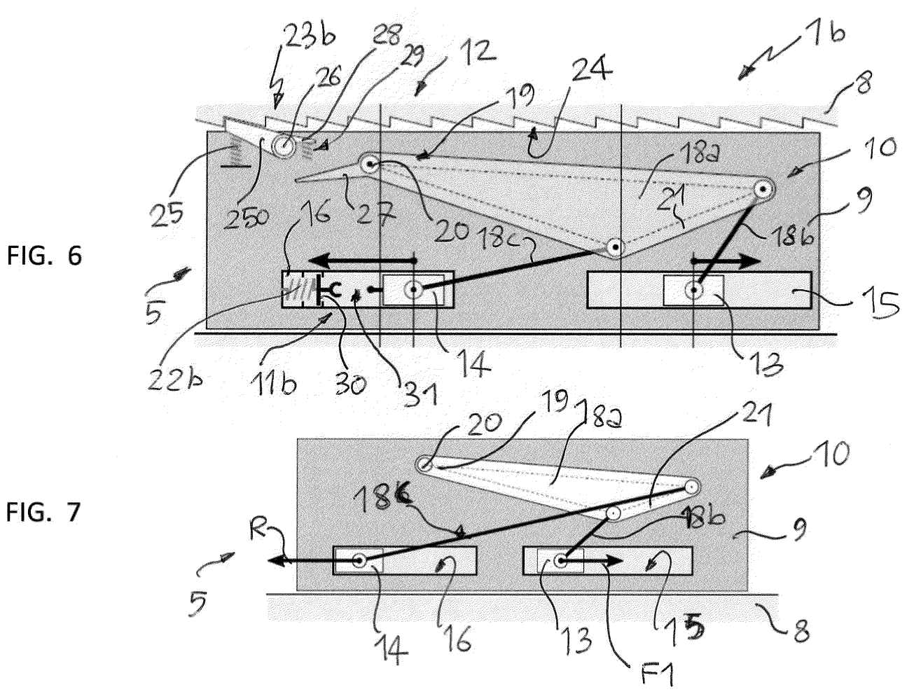

In both embodiments described, therefore, the mechanism 10 with the support 8 and the frame 9 constitute a kinematic system with two links, which is depicted more clearly, on its own, in FIG. 7.

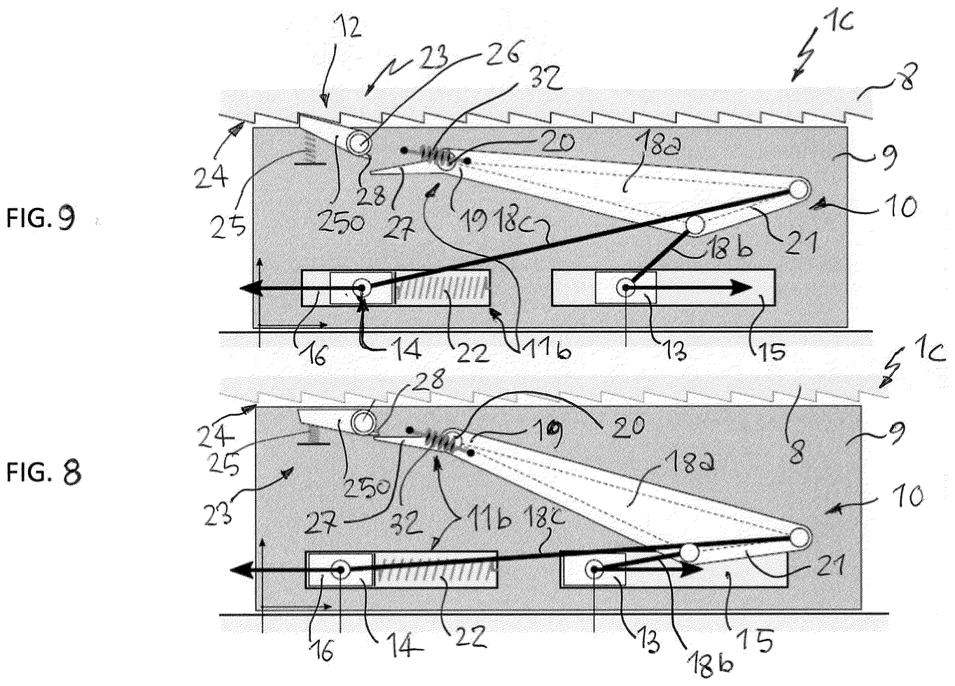

FIGS. 8 and 9 schematically show a third possible embodiment 1c of the parking brake device of the invention. Details which are similar or identical to those already described are indicated for the sake of simplicity with the same reference numbers.

The device 1c is identical to the device 1 described above, except that the triggering system 11 is replaced by a triggering system 11b which, in addition to the spring 22, further comprises a triggering calibrated spring 32, having a predetermined stiffness, which is bound at a first end thereof to the frame 9 and at the opposite end to the end 19 of the lever, but eccentrically with respect to the bolt 20. Thus, the spring 22 is not in fact indispensable for all of the embodiments according to this alternative.

In the position of start of triggering of the braking device 2, the device 1c is in the configuration shown in FIG. 8 and the spring 32 prevents rotation of the lever or member 18a, in that it generates a resistance torque or moment that is resistant with respect to the rotation bolt 20. When the force F1 exceeds the preloading of the spring 32 the resistance torque created thereby is overcome and the mechanism 10 “snaps” into the position of FIG. 9, in that the spring 32 rotates slightly, exceeding a dead center or point of singularity. The arm 27 is separated/moved away from the fin 28, releasing the latter, and the deadbolt 250 engages the toothing 24 (FIG. 9). At this point the device 1c functions identically to the devices 1 and 1b described above.

In all of the devices 1, 1b and 1c described so far, to disengage the braking device 2 it is sufficient to invert the direction of translation of the linear actuator 3; to be specific, F2 or R are the forces imposed on the skid 14, purely as a function of the clamping of the brake, not the direction of movement.

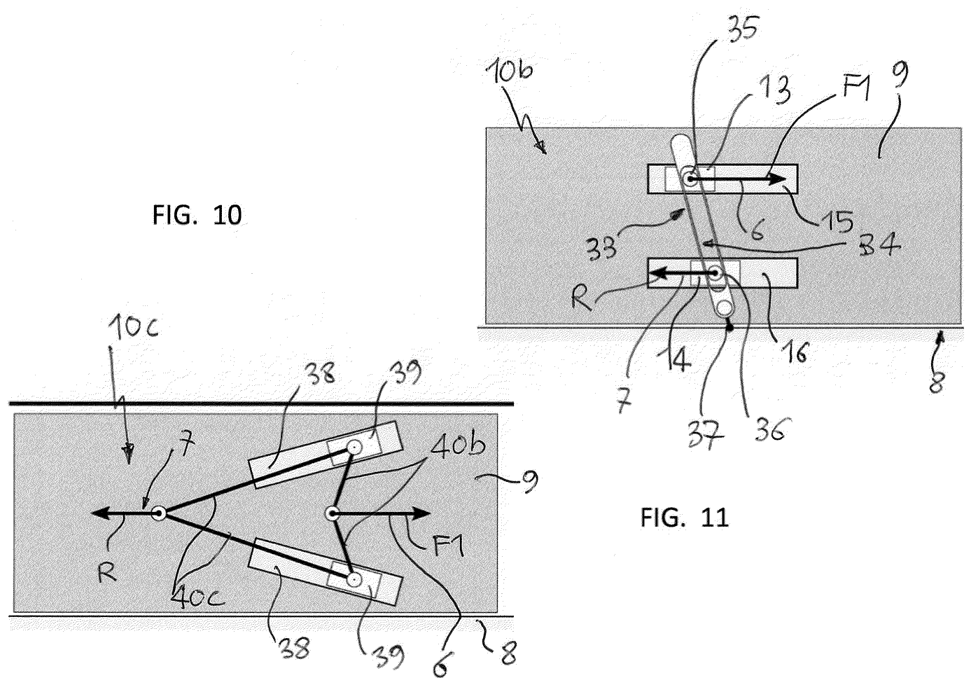

With reference to FIGS. 10 and 11, they schematically show two different possible embodiments of the force amplification mechanism 10.

FIG. 10 shows a force amplification mechanism 10b in which the frame 9 is provided with guides 15 and 16 arranged side by side, rather than in series or “in tandem” as in the devices of FIGS. 1-9. Within the guides 15, 16 the skids 13 and 14 are arranged slidingly, connected respectively to the section 6 and to the section 7 of the tie rod 4, which are therefore themselves also arranged side by side laterally, rather than aligned along the same direction or axis. The skids 13 and 14 are connected together by a lever 33 having a longitudinal slot 34 engaged slidingly by two bolts 35 and 36 which are integral, respectively, with the skid 13 and with the skid 14. The lever 33 is moreover hinged at one end thereof to a bolt 37 integral with the support 8.

FIG. 11 shows a force amplification mechanism 10c in which the frame 9 is provided with two guides 38 arranged inclined with respect to one another in such a way as to converge towards the braking device 2 and housing slidingly a pair of identical skids 39. The skids 39 are connected together, hingedly, by an articulated quadrilateral made up of two pairs of levers or connecting rods 40b and 40c, the levers or connecting rods 40b,c being hinged together at the opposite ends. The pair of connecting rods 40b is connected to the section 6 of the tie rod 4 and hence to the force F1 applied by the actuator 3, while the pair of connecting rods 40c is connected to the section 7 of the tie rod 4 and hence to the braking device 2 to be activated. The sections 6 and 7 are aligned with one another.

Other embodiments are possible for the force amplification mechanism 10 described and are obvious to those skilled in the art, and are therefore not described herein in detail although they are included in the invention.

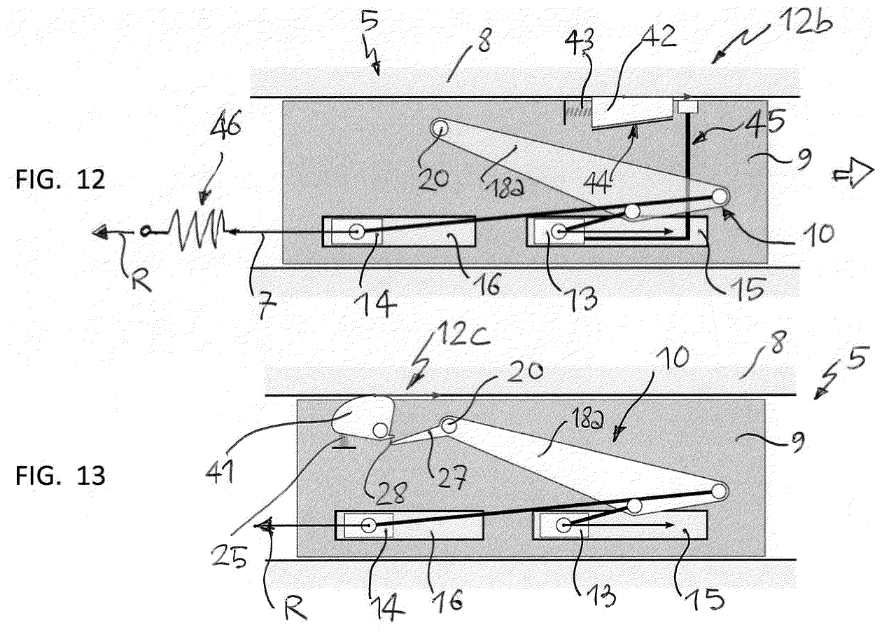

With reference to FIGS. 12 and 13, they schematically show two different possible embodiments of the force exchange system 12. Details which are similar or identical to those already described are indicated for the sake of simplicity with the same reference numbers.

FIG. 12 schematically shows a force exchange system 12b comprising a block or wedge 42 borne relatively moveable by the frame 9 against the action of a spring 43; the block or wedge 42 is able to engage the support 8 by a shape coupling, for example, as shown non-limitingly in FIG. 12, by means of an inclined plane 44 integrally borne by/attached to the support 8. The block or wedge 42 is moreover connected to the force amplification mechanism 10 by means of a rigid square 45 integrally borne by the skid 13.

In the initial phases of engagement of the parking brake device of the invention, the wedge 42 moves integrally with the frame 9, until it is wedged against the inclined plane 44, blocking the sliding of the frame 9; stopping is damped by the spring 43. In the phase of release of the braking device 2, when the mechanism 10 inverts its kinematic rotation, the rigid square 45 hits against the wedge 42 disengaging it from the inclined plane 44.

FIG. 13 schematically shows a force exchange system 12c similar to the system 12 described above, in which the harpoonism 23 is replaced by a cam element or “resistance brake” 41, having a shape with an elliptical profile, born hingedly rotatable by the frame 9 and cooperating with the force amplification mechanism 10 (by means of an arm 27 integral with the lever or member 18a and a fin 28 integral with the cam 41) against the action of a spring 25, to be prevented from cooperating by friction or other force coupling with the support 8 until the reaction force R exceeds said predetermined value. When the predetermined value is exceeded, the cam element or resistance brake 41 rotates and becomes “wedged” against the support 8, blocking the relative sliding of the frame 9 with respect to the support 8. In the initial phases of engagement of the parking brake device of the invention, the wedge 42 moves integrally with the frame 9, until it is wedged against the inclined plane 44, blocking the sliding of the frame 9; stopping is damped by the spring 43. In the phase of release of the braking device 2, when the mechanism 10 inverts its kinematic rotation, the rigid square 45 hits against the wedge 42 disengaging it from the inclined plane 44.

It is thus clear from what has been described above that the triggering system 11 consists of, or at least comprises, a calibrated element selected from the group consisting of: one or more elastic elements 22,32 having a predetermined stiffness; a snapping action locking/unlocking element 31; combinations thereof.

The calibrated element must moreover bound to, or be part of, said force amplification mechanism 12.

Likewise, the force exchange system 12 is selected in the group consisting of: a harpoonism 23 or 23b; a cam 41; a block or wedge 42 able to engage the support 8 by a force coupling; all as described above.

It is also clear from the above that the force amplification mechanism 10 must always be kinematically coupled to the force exchange system 12 so as to disengage the latter from the support 8 when the first section 6 of the tie rod 4 is moved by the linear actuator 3 towards the braking device 2 to progressively disengage it.

It is moreover clear that the force amplification mechanism 10 always comprises at least one articulated element (such as the connecting rod 18b, the connecting rods 40b or the lever 33) configured for passing beyond a dead center immediately before an end-of-stroke position of the linear actuator 3 (and of the skid 13 or of the two skids 39), in which the braking device 2 is fully engaged, so as to ensure a kinematic irreversibility to the force amplification mechanism 10 such that the braking device 2 remains engaged even when the linear actuator 3 is inactive.

According to another feature of the invention, lastly, the force amplification mechanism 10 may comprise (FIG. 12) a replaceable calibration spring 46, arranged on the load, hence on the section 7, and having a predetermined stiffness, and may be configured such that, for the same stroke of the linear actuator 3, the same said motion transmitting mechanism 5 having a variable transmission ratio can operate with a braking device 2 having reaction forces of different magnitude simply by replacing the calibration spring 46. This feature is illustrated by the graph in FIG. 15, which shows two force F (the force F2 or the reaction force R)/stroke Y (the available stroke of the skids or of the section 7 of the tie rod 4) curves, designated K1 and K2 respectively, where K is the stiffness of the spring 46.

As is clear, the left-hand segment of both curves is identical and represents the approach stroke, performed essentially at rest except for the opposing resistances of the mutual interactions between the mechanisms (caused mainly by friction). This stroke sees the braking elements 2 move until they make contact, and it is then that the play resulting from wear on the brake is taken up.

The right-hand segment of the curves represents the clamping stroke, which comes downstream of the approach stroke, in which the device 1 must exert the force necessary to guarantee parking of the vehicle. As can be seen, by using a calibration spring 46, it is possible to vary the overall stiffness of the mechanism 10 in such a way as to be able to change the slope of this part of the curve without modifying the entire device 1. In other words, the device 1 may be adapted to any load with a stiffness greater than the design stiffness. In the example shown, the curve K1 represents the behavior of the mechanism 10 in the absence of the spring 46, while the curve K2 represents the behavior of the mechanism 10 in the presence of a spring 46 of predetermined stiffness K.

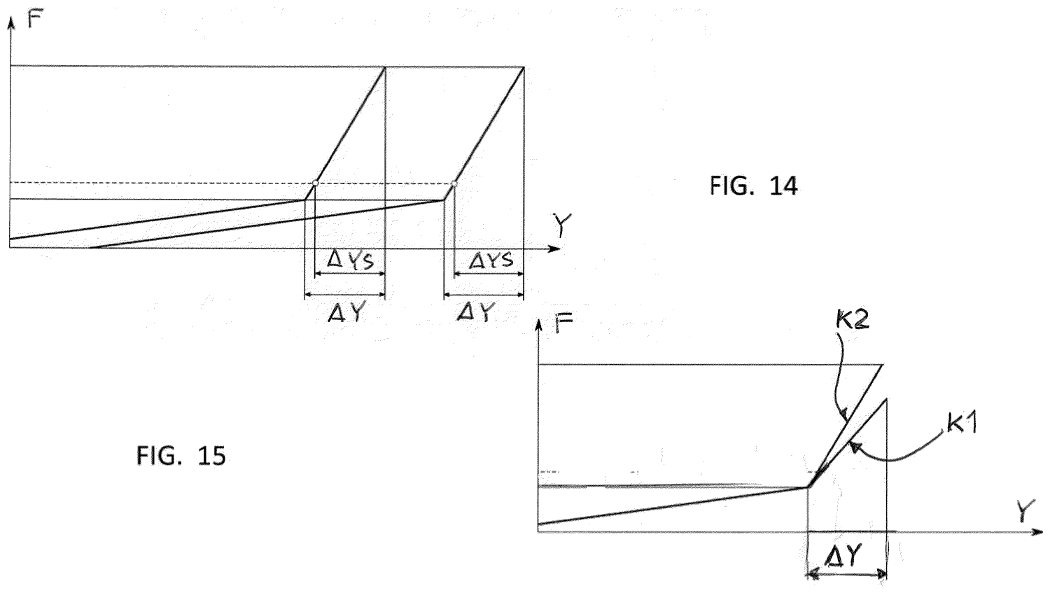

Likewise, the curves of FIG. 14 show how it is possible to obtain identical clamping strokes (ΔY) even when the overall strokes necessary to activate the braking device 2 are substantially different, remaining within a predetermined interval.

The advantages associated with the device described are clear:
The approach stroke, wherein lies the capacity to adapt to the play of the mechanism, varies as a function of the condition of use;
The behavior of the force curve before the start of the clamping phase makes it possible to perform this phase at high speed, i.e. without relatively long waiting times for automatic engagement of the braking device 2, as in known electronic braking devices;
The maximum force F1max required from the activation device 3 is substantially less than the maximum force F2max exerted, which makes it possible to use smaller, less powerful and less expensive actuators;

The clamping stroke segment ΔY is of constant length.

The main quality of the devices described is the ability to modify their modes of operation, with different behavior in the approach phase and in the clamping phase. The clamping phase, in which it is beneficial to have variable force transmission ratios, is performed using a mechanism with predetermined kinematic characteristics. The motion transmission mechanisms that can be used may differ only as regards the switch from one operational mode to another.

All of the aims of the invention are therefore achieved.

1. The parking brake according to claim 11, wherein the motion transmitting means is configured so that a translatory movement of the first tie rod section by the linear actuator in a first direction at a first speed up to a first level of force applied by the linear actuator causes a translatory movement of the second tie rod section in the first direction at the first speed and such that when the first level of force exceeds a first value in response to a reaction force of the braking device exceeding a second value, the transmission ratio of the motion transmitting means is changed such that the movement of the first tie rod section by the linear actuator in the first direction at the first speed causes a translatory movement of the second tie rod section in the first direction at a second speed less than the first speed.

2. The parking brake according to claim 1, wherein the motion transmitting means comprises:
a support;
a frame slidably supported by the support for movement in the first direction;
force amplification means carried by the frame and mechanically connecting the first tie rod section and the second tie rod section;
triggering means for selectively changing the transmission ratio; and
force exchange means for blocking a sliding of the movable frame (9) and making it integrally rigid with the support;
wherein the force amplification means is configured to actuate the force exchange means following an activation of the force amplification means by the triggering means, and apply to the second tie rod section a progressively increasing force.

3. The parking brake device according to claim 2,
wherein the force amplification means and the force exchange means are configured to transfer to the support a portion of said reaction force (R) such that, while the linear actuator applies the first level of force to the first tie rod section, the force amplification means applies a second force to the second tie rod section that is always greater than the first level of force and said reaction force.

4. The parking brake according to claim 2,
wherein a first end of the first tie rod section is connected to a first skid slidably supported by a first guide on the frame and a first end of the second tie rod section is connected to a second skid slidably supported by a second guide on the frame, and
wherein the force amplification means comprises one or more connecting rods articulately constrained to the frame and hingedly bound to each other and/or to the first skid or the second skid.

5. The parking brake according to claim 4, wherein the triggering means is configured to lock the force amplification mechanism by preventing relative rotation between the one or more connecting rods and the frame until said reaction force exceeds the second value.

6. The parking brake according to claim 5, wherein the triggering means comprises a calibrated element selected from the group consisting of: one or more elastic elements having a predetermined stiffness and a snapping action locking/unlocking element;
wherein said calibrated element is connected to or part of said force amplification means.

7. The parking brake according to claim 2,
wherein the force exchange means is selected from the group consisting of:
a toothing integral formed with the support and a deadlock pivotably mounted to the frame so as to cooperate with, or be constrained to, the force amplification means to be prevented from engaging the toothing until said reaction force (R) exceeds said second value;
a cam element borne hingedly rotatable by the frame and cooperating with the force amplification means against the action of a spring to be prevented from cooperating by friction or other force coupling with the support, until said reaction force exceeds said second value; and
a block or wedge borne movably by the frame against an action of a spring and able to engage the support by of an inclined plane, the block or wedge being connected to the force amplification means by a rigid square.

8. The parking brake according to claim 2, wherein the force amplification means is kinematically coupled to the force exchange means so as to disengage the force exchange means from the support when the first tie rod section is moved by the linear actuator in a second direction opposite the first direction to progressively disengage it.

9. The parking brake according to claim 2, wherein the force amplification means comprises at least one articulated element configured to move beyond a dead center immediately before an end-of-stroke position of the linear actuator when the braking device is fully engaged so as to ensure a kinematic irreversibility to the force amplification means such that the braking device remains engaged even when the linear actuator is inactive.

10. The parking brake according to claim 2, wherein the force amplification means comprises a replaceable calibration spring having a predetermined stiffness and being configured such that, for a given stroke of the linear actuator, the same said motion transmitting mechanism having a variable transmission ratio can operate with a braking device having reaction forces of different magnitude simply by replacing the calibration spring.

11. A vehicular parking brake comprising:
a braking device,
a linear actuator,
a first tie rod connected to the linear actuator,
a second tie rod connected to the braking device, and
motion transmitting means for moving the second tie rod in response to a movement of the first tie rod with a variable transmission ratio.

12. A vehicular parking brake comprising:
a braking device,
a linear actuator,
a fixed support,
a frame slidably mounted on the fixed support for linear movement relative to the frame in a first direction and in a second direction opposite the first direction,
a first skid slidably mounted to a first linear guide on the frame,
a second skid slidably mounted to a second linear guide on the frame,
a first tie rod connecting the linear actuator to the first skid,
a second tie rod connecting the second skid to the braking device,
means for selectively blocking movement of the frame relative to the fixed support,
a triangular body having a first vertex pivotably mounted to the frame, a second vertex and a third vertex,
a first connecting rod extending from the first skid to the second vertex, and
a second connecting rod extending from third vertex to the second skid.

13. The parking brake according to claim 12,
wherein the means for selectively blocking movement of the frame comprises notches on the fixed support and a pawl pivotably mounted on the frame and movable into and out of engagement with the notches.

14. The parking brake according to claim 13,
wherein the pawl is configured such that pivotable movement of the triangular body about the first vertex in a first rotational direction engages the pawl with the notches and pivotable movement of the triangular body in a second rotational direction disengages the pawl from the notches.
